(19) United States
(12) Patent Application Publication
(10) Pub. No.: US 2024/0409174 A1
(43) Pub. Date: Dec. 12, 2024

(54) MODULAR EXTRUDED CHASSIS FOR SMALL ELECTRIC VEHICLES

(71) Applicant: ALI KAZEMKHANI, NORTH VANCOUVER (CA)

(72) Inventor: ALI KAZEMKHANI, NORTH VANCOUVER (CA)

(21) Appl. No.: 18/804,439

(22) Filed: Aug. 14, 2024

(51) Int. Cl. B62K 5/01; B62J 43/16; H01M 50/204; H01M 50/24; H01M 50/249

(52) U.S. Cl. CPC B62K 5/01; B62J 43/16; H01M 50/204; H01M 50/24; H01M 50/249; H01M 2220/20

(57) ABSTRACT

An extruded chassis structure for an electric platform vehicle is provided. The chassis structure includes a top elongated wall arranged in a spaced-apart relationship with a bottom elongated wall and a first elongated side wall arranged in a spaced-apart relationship with a second elongated side wall. The top wall, the bottom wall, and the first and second side walls are interconnected using at least four T-slot profiles, each located at a corner of the extruded chassis structure. The chassis structure also includes a front-end cap, and a rear-end cap forming an enclosed space there inside. Each of the T-slot profiles includes tracks to facilitate mounting vehicle-related components and vehicle-related attachments to the extruded chassis structure.

### TECHNICAL FIELD

The present disclosure relates to chassis platforms for electric vehicles and more particularly, to a versatile chassis structure in the form of an extruded profile for use with an electrically powered vehicle, which can increase the degree of freedom in design changes to the vehicle, reduce manufacturing cost and time, provide a safe, waterproof, dustproof solution for housing battery modules and other electronics associated with the electric vehicle.

### BACKGROUND

In general, an electric vehicle refers to a vehicle that uses electricity as power and other electronics. Electricity is made available using portable battery modules located in the vehicles. In other words, electric vehicles acquire driving energy by rotating a motor with electricity supplied through battery modules. The electric vehicles are eco-friendly and can be operated at low operation cost, and thus have an advantage in an economic aspect. Thus, electric vehicles are gaining popularity over fossil fuel-powered vehicles. Such electric vehicles usually have a structure in which one or more batteries and heat-dissipating electronics are safely installed at the bottom of the body of the vehicle, and a front wheel chassis module and a rear wheel chassis module, on which wheels of the vehicle are installed, are also installed at the bottom of the body of the vehicle.

Traditionally, when the body's shape of such a vehicle needs to be changed or a vehicle requires length or width extension or requires external attachments to be added to the vehicle body or chassis for various purposes, the designs of the battery modules require changes or structure housing the batteries, electronics require changes, the front wheel chassis module and the rear wheel chassis module, which are mounted on the body of the vehicle, need to be changed as well. Further, the addition of external attachments to the body, and chassis of the vehicle involves CNC machining, cutting, welding, drilling holes, and so on which requires the use of a lot of tools to handle changes.

Extruded profiles of light metals such as Aluminium are gaining increasing popularity in addition to forged chassis structures for electric vehicles. When chassis components such as suspension arms of extruded profiles with closed or open cross sections are involved, and the addition of external components to the chassis is required, the state of art chassis structures (made of extruded profiles) do not provide any flexibility in terms of changing length or width of the chassis structure or to add external components. Further, Chassis structures of known extruded profiles usually have cross sections that must be dimensioned over their entire length to suit the stiffness-critical section, even though this section normally constitutes only a small portion of the overall length of the structure. Thus, the extruded profiles are manufactured with a cross-sectional geometry whose entire length is dimensioned to cope with an expected maximum load. Excess material that does not contribute to the stiffness and strength behaviours of the chassis structure is normally stripped mechanically to reduce the weight of the chassis structure. This requires additional expensive measures for machining the chassis structures and also for recovery and use of produced light metal scrap.

The chassis platform is the most important part of an electric vehicle especially a 4-wheeled electric vehicle such as an ATV/UTV, a car, a micro truck, or other vehicle. To meet the performance requirements of the automotive market dominated by electric vehicles, the design of electric vehicles is required to be lightweight, durable, and versatile. In addition to the battery, the chassis of the electric vehicle carries a considerable amount of weight. Specifically, the traditionally used chassis for electric vehicles is made of heavy metals. They are of fixed shape or size and are appropriately bent, welded, and CNC machined to gain the desired shape. The manufacturing time and cost of such a chassis is usually higher. Further, it is impossible for such electrical vehicles using such fixed length and width chassis structures to be upgraded in terms of length and width or attach external components thereto (such as footsteps, fender support, and front and rear bumper brackets).

Further, the extruded chassis structures known in the art are conventional metallic solutions made using molding, CNC machining, cutting, and drilling activities in a fixed length and they do not offer watertight and airtight sealing for the electronics components usually mounted inside those chassis structures, thereby risking the durability of the product and triggering the frequent failure of the vehicles employing such chassis structure.

In the light of foregoing, the inventor herein has come up with a noval, versatile chassis structure for use with electric vehicles, which provides freedom of design changes to the electrical vehicle, reduces manufacturing cost and time, provides a safe, waterproof, dustproof solution for housing battery modules, and other electronics related to electric vehicles.

### BRIEF SUMMARY

It is an object of the present invention to provide a versatile chassis structure in the form of an extruded profile made of preferably a light metal. Further, the proposed chassis structure is important given its potential for lightweight construction of an electric vehicle with the ability to support enough weight and be strong enough to protect its occupants in case of a crash and rigid enough to resist torsional vibration which is the twisting force on the chassis due to loading and road conditions.

It is an object of the present invention to provide a versatile chassis structure in the form of an extruded profile that does not require any welding process for connecting any kind of vehicle-related components and attachments.

It is another object of the present invention to provide a chassis structure in the form of an extruded profile that has a less massive cross-sectional configuration compared to forged counterparts currently in use in different vehicles.

It is an object of the present invention to provide a chassis structure in the form of an extruded profile that's able to carry heavy battery packs safely, and other electronics safely inside and is lightweight to provide better performance and efficiency to the electric vehicle.

It is another object of the present invention to provide a chassis structure in the form of an extruded profile that allows easy conversion of a 4-wheeled electric mobile platform vehicle (also referred to as “Utility Personal Transporter (UPT)”) into one or more useful vehicle types such as but not limited to an ATV/UTV, a car, a micro truck, or other work vehicles for carrying out different works to meet needs of a user. The conversion from one vehicle type to another vehicle type is made easy by the proposed extruded chassis structure. The proposed chassis structure allows various vehicle-related components and attachments to fasten or be removed to and from the chassis structure. This also makes the proposed chassis structure versatile using which a vehicle can be easily converted (or change the vehicle design) from one vehicle type to another vehicle type for carrying out search and rescue missions, animal farm surveillance, eco-tours, urban commuting, load carrying, recreational uses, and so on.

It is another object of the present invention to provide a chassis structure in the form of an extruded profile that would help in changing the wheelbase length of the chassis structure used in an electric vehicle using simple tooling.

It is another objective of the present invention to provide a chassis structure in the form of an extruded profile that's waterproof and airproof to safely house the electronics, motor controllers, batteries, and other components related to the electric vehicle.

It is another objective of the present invention to provide a chassis structure in the form of an extruded profile that allows multiple similar chassis structures to interconnect sidewise or lengthwise to create a chassis structure of any length and width. Further, the chassis structure of the proposed invention can be interconnected with the partial section of the same chassis structure.

Various embodiments of the present invention describe an extruded chassis structure for an electric mobile platform vehicle that includes a top elongated wall arranged in a spaced-apart relationship with a bottom elongated wall, and a first elongated side wall arranged in a spaced-apart relationship with a second elongated side wall. The top wall, the bottom wall, and the first and second side walls are interconnected using at least four T-slot profiles, each located at a corner of the extruded chassis structure. Each of the T-slot profiles comprises at least one track to facilitate mounting one or more vehicle-related attachments to the extruded chassis structure without needing any kind of welding.

In an embodiment, the extruded chassis structure further comprises a first end and a second end that are covered by a front end cap, and a rear end cap forming an enclosed space there inside. The enclosed space further comprises an enclosure formed therein using a pair of separators.

In an embodiment, the extruded chassis structure is quadrilateral shaped and made of a light metal.

In an embodiment, each of the first elongated side wall and the second elongated side wall comprises a first opening, and a second opening to facilitate the configuration of the suspension systems for the electric mobile platform vehicle.

In an embodiment, the extruded chassis structure includes at least one threaded reinforcing member configured underside at least one of: the top elongated wall, and the bottom elongated wall to reinforce the top elongated wall and the bottom elongated wall enhancing their rigidity. The at least one reinforcing member is a threaded C channel extending along the length of the extruded chassis structure. The at least one reinforcing member is adapted for connecting the front end wall, and the rear end wall at the first end and the second end of the extruded chassis structure. The at least one reinforcing member is configured for at least mounting one or more frame extenders, mounting the suspension systems for the electric mobile platform vehicle, supporting one or more battery modules configured within the enclosed space of the extruded chassis structure, acting as impact and scratch guard for the bottom elongated wall, acting as mud and water channels.

In an embodiment, each of the T-slot profiles comprises a void opening for at least providing torsional stiffness to the extruded chassis structure, a safe passage for cables and brake lines of the electric mobile platform vehicle, torsional stiffness to the at least one track of the T-slot profiles.

In an embodiment, the front end cap, and the rear end cap comprises one or more attachment provisions to mount the front end cap, and the rear end cap at the first end and the second end of the extruded chassis structure by connecting the front end cap, and the rear end cap using one or more fasteners.

In an embodiment, the one or more attachment provisions are used for connecting one or more vehicle related attachments utilizing the one or more fasteners.

In an embodiment, four wheels of the electric mobile platform vehicle are connected to the extruded chassis structure on the side walls utilizing respective pairs of control arms which are connected to the at least one track of the T-slot profiles in proximity to the first and second in an embodiment, openings.

In an embodiment, the at least one track comprises three longitudinal solid-walled sides, and a longitudinal slot for the passage of a fastener for connecting the one or more vehicle-related attachments to the extruded chassis structure.

In an embodiment, the top elongated wall comprises a cover configured to allow accessibility to the one or more battery modules housed within the enclosure of the extruded chassis structure.

In an embodiment, the enclosed space of the extruded chassis structure houses one or more controllers and other electronics positioned adjacent to the first and second side walls of the extruded chassis structure to facilitate effective heat dissipation to the first and second side walls of the extruded chassis structure.

In an embodiment, the first opening, and/or the second opening facilitates changing the wheelbase length of the extruded chassis structure by moving the corresponding pair of control arms along the at least one track of the T-slot profiles.

In an embodiment, two of the at least four T-slot profiles, each connecting the top elongated wall to the first and second side walls comprises a lip extending therefrom acting as a support for mounting the cover thereon.

Various advantages and features of the present invention are described herein with specificity to make the present invention understandable to one of ordinary skill in the art, both with respect to how to practice the present invention and how to make the present invention.

### BRIEF DESCRIPTION OF THE DRAWINGS

The above set forth and other features of the present invention are made more apparent in the ensuing description of the preferred embodiments when read in conjunction with the attached drawings, wherein:

FIG. 1 shows a chassis structure in the form of an extruded profile for use with an electrically powered vehicle with its front end cap removed, according to an embodiment of the present invention.

FIG. 2 shows a cross-sectional view of the chassis structure of FIG. 1 taken along A-A.

FIGS. 3 and 4 show front perspective views of the chassis structure of FIG. 1 with footsteps configured on either side of the chassis, according to an embodiment.

FIG. 5 shows the chassis structure of FIG. 1 with footsteps configured on either side of the chassis, a pair of control arms for connecting each of the tires/wheels, a steering assembly, and an operator seat removably mounted on an upper control arm of the pair of control arms connected to the chassis structure.

FIG. 6 shows a perspective view of a four-wheeled mobile platform vehicle formed using the chassis structure of FIG. 1, according to an embodiment of the present invention.

FIG. 7 shows a sectional view of the four-wheeled mobile platform vehicle of FIG. 6 highlighting a pair of control arms connecting the chassis to each of the tires/wheels.

FIG. 8 shows a cross-sectional view of the chassis structure in the form of an extruded profile illustrated in FIG. 3 taken along B-B for highlighting the important features associated with the extruded profile.

FIG. 9 shows a cross-sectional view of the four-wheeled mobile platform vehicle of FIG. 6 along A-A′ formed using the chassis structure of FIG. 1.

FIG. 10 is an enlarged sectional view of FIG. 9 highlighting an upper portion of the chassis structure.

FIGS. 11 and 12 show views of the four-wheeled mobile platform vehicle of FIG. 6 in a more simplified form with a cover over an enclosed space holding one or more battery modules removed, according to an embodiment.

FIGS. 13 and 14 are sectional views taken from FIG. 6 to illustrate a mechanism for changing the wheelbase length of the chassis structure used in an electric vehicle, in accordance with an exemplary embodiment.

Identical reference numerals in the figures are intended to indicate like parts, although not every feature in every figure may be called out with a reference numeral.

### DETAILED DESCRIPTION

In the drawings, the relative sizes of elements, layers, and regions may be exaggerated and/or simplified for clarity. Spatially relative terms, such as “beneath,” “below,” “lower,” “under,” “above,” “upper,” “front” and “rear” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and not intended to be limiting. As used herein, the singular forms “a” and “an” are intended to include the plural forms as well, unless the context clearly indicates otherwise. It will be further understood that the terms “comprises,” “comprising,” “includes,” and “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” “along,” and similar terms are merely used as terms of approximation and are intended to account for the inherent variations in measured or calculated values that would be recognized by those of ordinary skill in the art. Further, the use of “may” when describing embodiments of the present invention refers to “one or more embodiments of the present invention.

For this disclosure, the terms “electrically powered vehicle”, and “electrical vehicle” are interchangeably used and the terms refer to a 4-wheeled electric mobile platform vehicle or electric mobile platform vehicle (also referred to as “Utility Personal Transporter (UPT) in inventor's US patent application number Ser. No. 18/631,550) that's capable of being converted or capable doing design changes to come up with one or more useful vehicle types such as but not limited to an ATV/UTV, a car, a micro truck, or other work vehicles for carrying out different works to meet the need of users. Further, in this disclosure, the term “vehicle-related components” refers to essential components of the vehicle without which the vehicle cannot function such as for example, suspension systems, steering system. Likewise, the term “vehicle-related attachments” refers to components that may be optional but not essential for connecting to a vehicle, for example, seats, fenders, bumpers, etc.

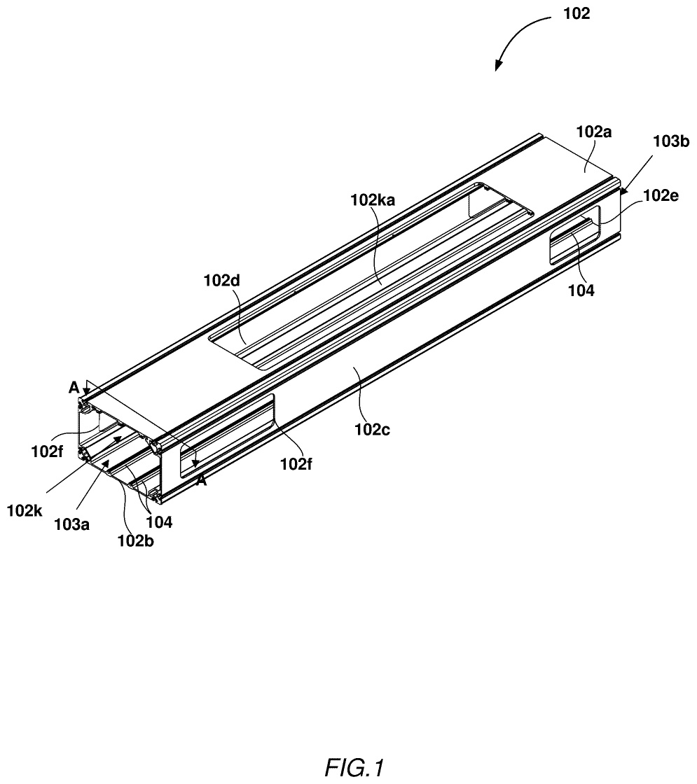

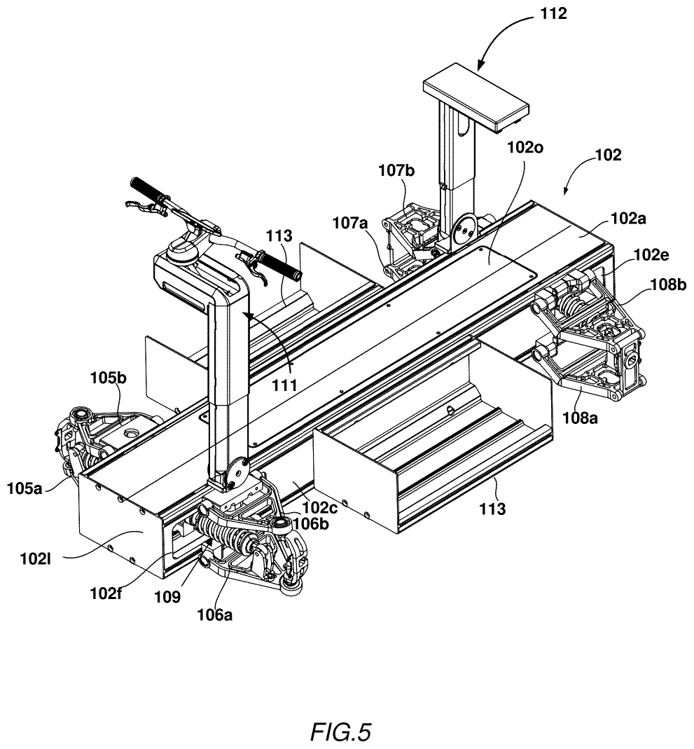

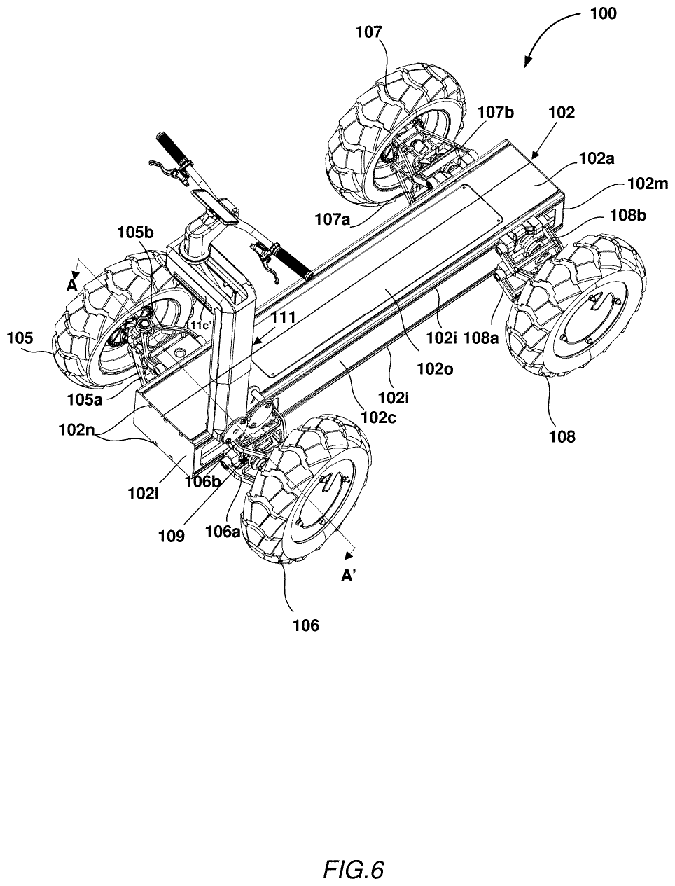

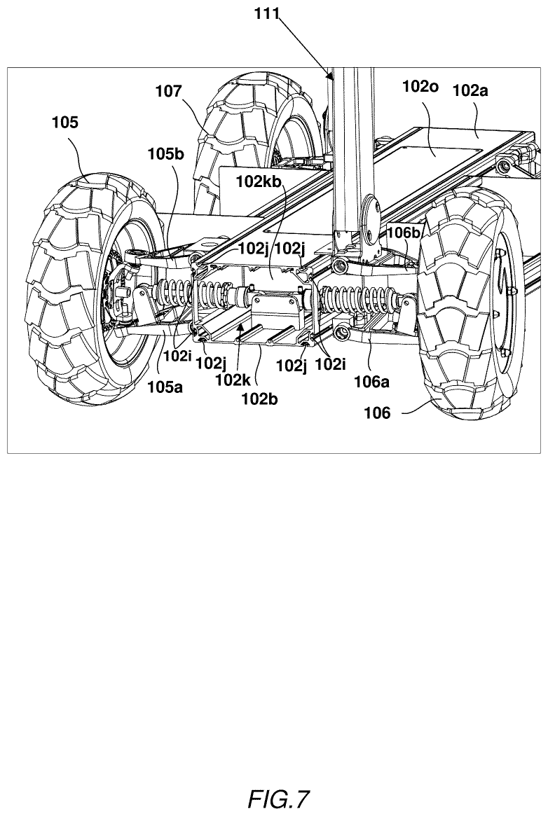

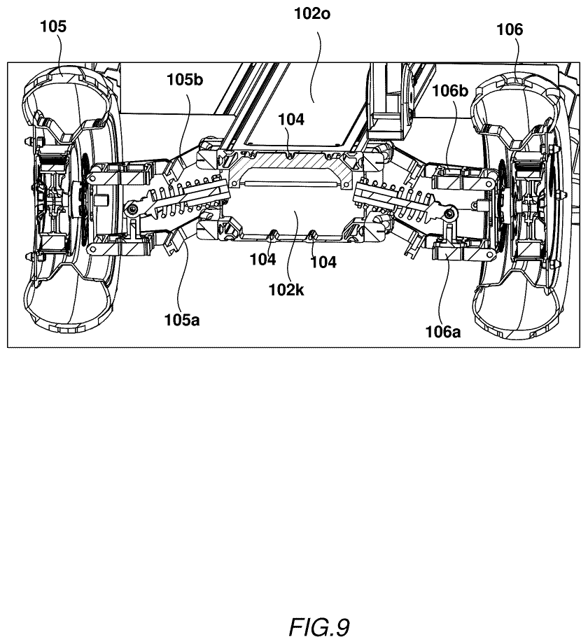

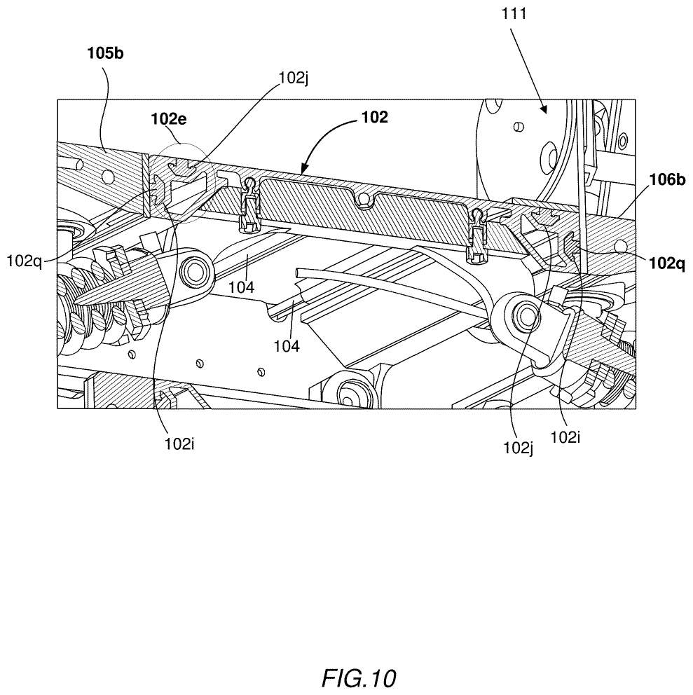

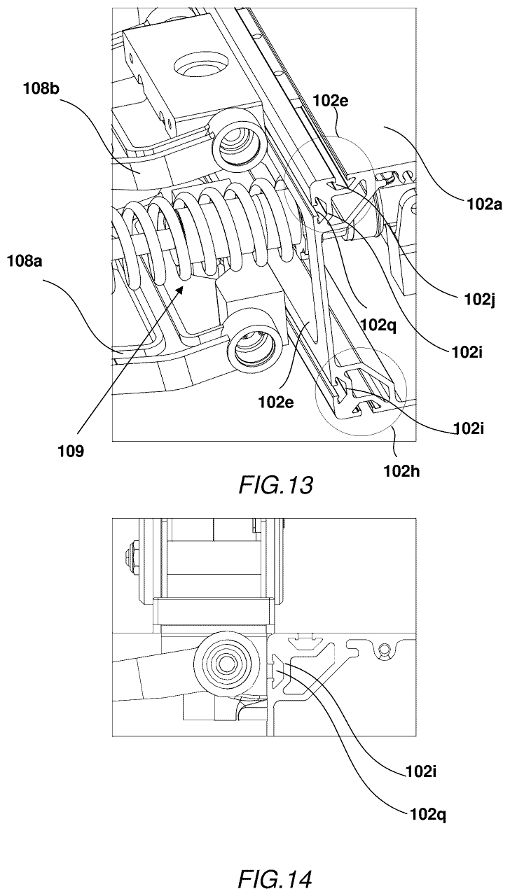

Referring to the accompanying figures, FIGS. 1-14, specifically to FIGS. 1-4, a chassis structure in the form of an extruded profile for use with an electrically powered vehicle in accordance with various embodiments is shown. The chassis structure 102 will be referred to as extruded chassis structure 102. The extruded chassis structure 102 is of a predefined length and a predefined width. The extruded chassis structure 102 includes a top elongated wall 102a arranged in a spaced-apart relationship with a bottom elongated wall 102b. The extruded chassis structure 102 further includes a first elongated side wall 102c arranged in a spaced-apart relationship with a second elongated side wall 102d. The top elongated wall 102a, the bottom elongated wall 102b, and the side walls 102c, and 102d are made in predefined length and width and are made using suitable metallic sheets of light metal, for example, but not limited to Aluminium. Similarly, the two side walls 102c, and 102d are made in predefined lengths and widths using suitable metallic sheets of light metal for example, but not limited to Aluminium. The top elongated wall 102a, and the bottom elongated wall 102b are made identical in shape and size. The two side walls 102c, and 102d are also made identical in shape and size.

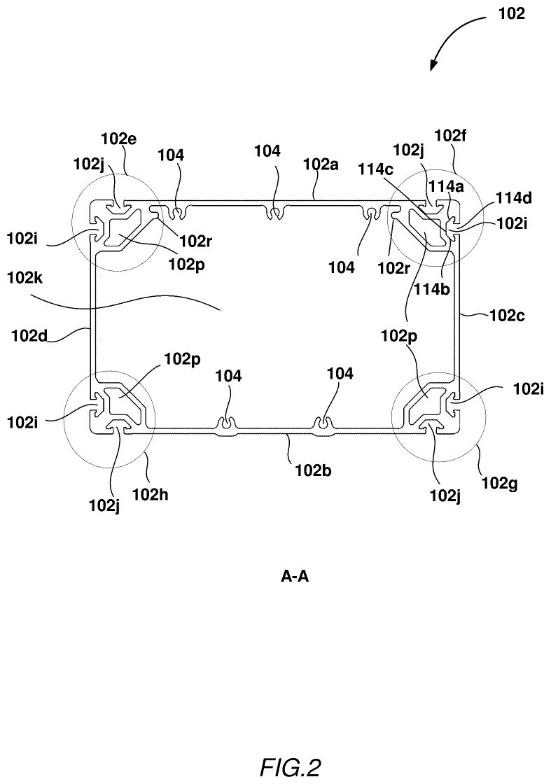

Further, as best seen in FIG. 2, the top elongated wall 102a, the bottom elongated wall 102b, and the side walls 102c, and 102d are all interconnected using at least four T-slot profiles 102e-102h. It should be understood by those skilled in the art that it is possible to have fewer T slot profiles as part of the extrusion 102 depending upon the requirements of the attachments that need to be attached to the vehicle 100, depending upon the requirement of the suspension systems.

The T slot profile 102e connects an end of the top elongated wall 102a with an end of the side wall 102d. The T slot profile 102f connects an end of the top elongated wall 102a with an end of the side wall 102c. The T slot profile 102g connects an end of the bottom elongated wall 102b with an end of the side wall 102c. Likewise, the T slot profile 102h connects an end of the bottom elongated wall 102b with an end of the side wall 102d. As seen, each of T-slot profiles 102e-102h is located at a corner of the extruded chassis structure 102.

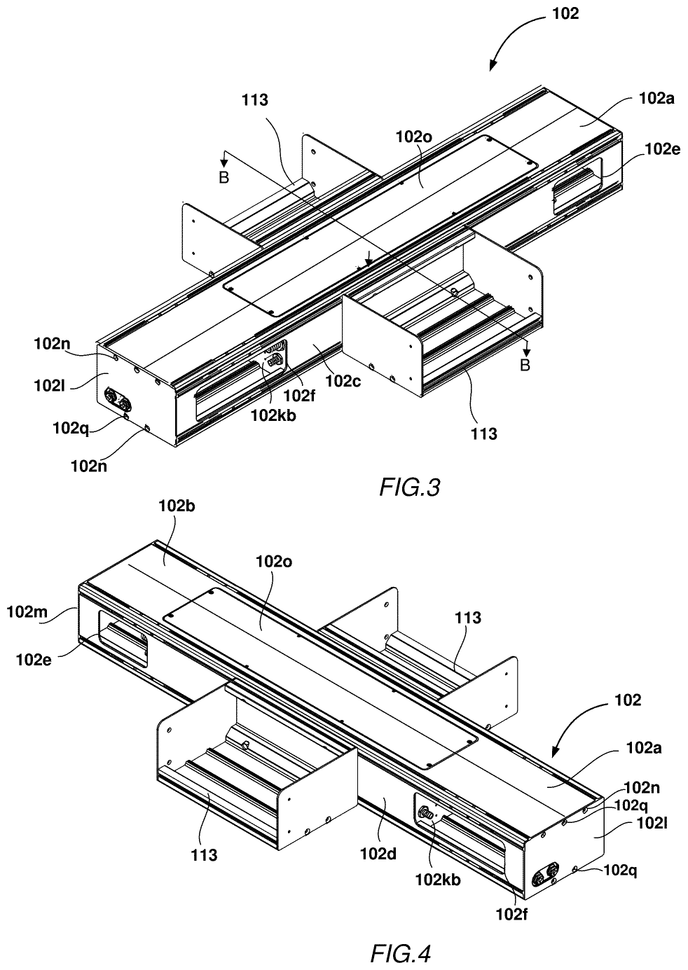

Additionally, as best seen in FIGS. 3-4 in conjunction with FIG. 1, the extruded chassis structure 102 includes a first end 103a and a second end 103b. The first end 103a is covered using a front end cap 102l, and the second end 103b is covered using a rear end cap 102m forming an enclosed space 102k inside the extruded chassis structure 102. The front and rear end caps 102l and 102m provide torsional stiffness to the chassis structure against twisting/bending of the structure 102. The enclosed space 102k is further divided to form an enclosure 102ka that preferably houses one or more battery modules 110, one or more motor controllers 110a, and other electronics. The enclosure 102ka is waterproof. A front separator 102kb (FIGS. 3 and 4), and a rear separator 102kc (not seen) separate the enclosure 102ka from the entire length of the enclosed space 102k. The separators 102kb, 102kc provide sealing from water from the front end and rear end of the enclosure 102ka. The cover 102o seals the enclosure 102ka from top whereas the bottom elongated wall 102b seals the enclosure 102ka from the bottom to make the enclosure 102ka waterproof. The motor controllers 110a and other electronics are preferably disposed of or located adjacent to the side walls 102c, and 102d (of the enclosure 102ka) for effective heat dissipation. In other words, the walls 102c, and 102d act as a means for the controllers 110a, and other electronics to dissipate therethrough. Further, the top elongated wall 102a includes a cover 102o to allow accessibility to the battery modules 110, one or more motor controllers 110a, and other electronics.

As seen, the extruded chassis structure 102 is quadrilateral shaped. In an embodiment, the extruded chassis structure 102 is cuboidal shaped. In some other embodiment, the extruded chassis structure 102 is square-shaped. The extruded chassis structure 102 in the preferred embodiment is made as a unitary product or a single-piece product. In some other embodiments, the extruded chassis structure 102 may be made in two or more pieces that may be fixedly joined together (by wending for example) or removably joined together using known mechanisms to form the extruded chassis structure 102.

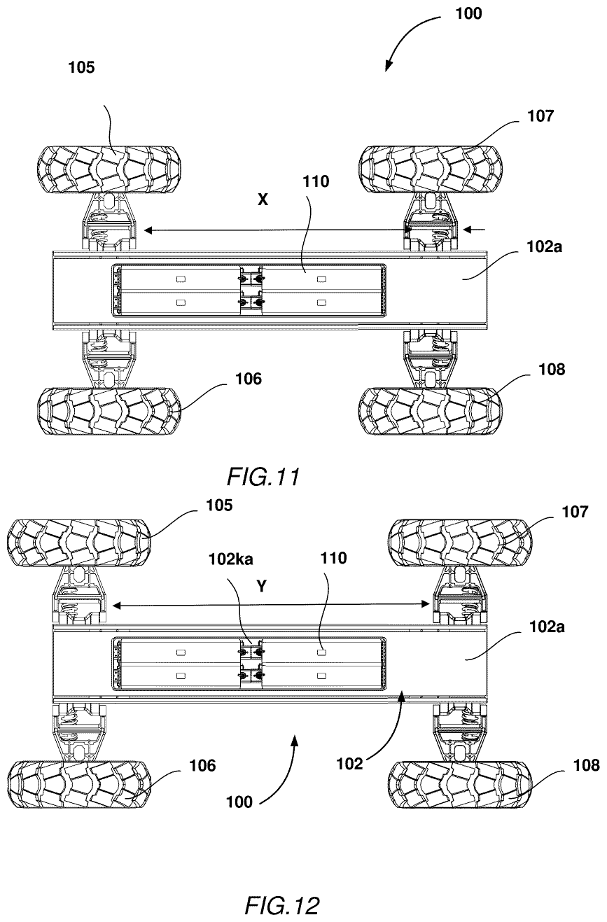

Further, referring to FIGS. 1, 3-7, 9-10, each of the first elongated side wall 102c and the second elongated side wall 102d includes a first opening 102e, and a second opening 102f. The openings 102e, and 102f facilitate the configuration of suspension systems 109 for the electric platform vehicle 100. In an embodiment, the suspension systems 109 are relatively flat suspension systems. Each of the suspension systems 109 includes a shock absorber and a coil spring wound around the shock absorber. The suspension system 109 is configured near each of the four wheels 105-108 substantially in a horizontal orientation. The suspension system 109 is connected to a control arm of the pair of control arms (105a, 105b) or (106a, 106b) or (107a, 107b) or (108a, 108b) using a first bracket at its first end and to a second bracket positioned inside and substantially at the centreline of the chassis structure 102 within the enclosed space 102k. The first opening (102e) and/or the second opening (102f) facilitates in changing the wheelbase length of the extruded chassis structure 102 by moving the corresponding pair of control arms (105a, 105b) or (106a, 106b) or (107a, 107b) or (108a, 108b) along the at least one track 102i of the T-slot profiles 102e-102h as will be explained with respect to FIGS. 11-14.

Turning back to at least FIG. 2, each of the four T-slot profiles 102e-102h includes at least one track 102i, 102j to facilitate mounting one or more vehicle-related components to the extruded chassis structure 102. The vehicle related components may include but not limited to suspension systems 109, steering assembly 111. Although the T-slot profiles 102e-102h are shown to have two tracks 102i, 102j, it should be understood that it is possible to have just one track 102i or 102j or even more number of tracks depending upon the design requirement.

In the accompanying figures, the T-slot profiles 102e-102h are shown to include two tracks, namely a track 102i, and a track 102j. The track 102i of the T-slot profiles 102e-102h are configured to connect various vehicle-related components sidewise or on top. For example, suspension systems 109 are seen connected to the extruded chassis 102 via these tracks 102i of the T-slot profiles 102e-102h as best seen in at least FIGS. 3-5, and 8. The four wheels 105-108 of the electric mobile platform vehicle 100 are connected to the extruded chassis structure 102 on the side walls 102c, 102d utilizing respective pairs of control arms (105a, 105b) or (106a, 106b) or (107a, 107b) or (108a, 108b) which are connected to the tracks 102i of the T-slot profiles 102e-102h in proximity to the openings 102e, 102f. Further, the footsteps 113 are shown connected to the chassis 102 using the tracks 102i. The footsteps 113 are provided with slots similar to the slots 102n and attached to the track 102i using rail nuts and bolts. In the example, the footsteps 113 are shown to be a portion of the proposed extruded chassis 102 (half a section). Many other attachments such as one or more supports for mounting one or more fenders for front and rear uses (not seen), front, and rear bumper mounting brackets (not seen), and one or more additional similar extruded chassis structures to increase the width or length of the extruded chassis structure 102 (to make vehicle with larger length and width) can also be connected similarly. These are merely exemplary components and attachments. It is possible to connect other vehicle related attachments that may be suitable for use with the chassis 102 without limitation. To elaborate, as seen in FIG. 2, each of the tracks 102i of the T-slot profiles 102e-102h include three longitudinal solid-walled sides 114a-114c, and a longitudinal slot 114d for passage of a fastener (preferably a rail nut) 102q for connecting the one or more vehicle-related attachments to the extruded chassis structure 102. In assembly, the rail nuts 102q are inserted into the tracks 102i with their head within the tracks 102i and then the vehicle-related attachments discussed above are bolted using suitable bolts (not seen). This helps avoid any need for welding.

Similarly, the track 102j of the T-slot profiles 102e-102h are configured to connect various other suitable vehicle-related components and/or attachments on top or bottom of the chassis 102. For example, a steering assembly 111 is vehicle related component, an operator seat 112, a covered body (not seen), one or more racks (not seen) are vehicle related attachments that may be mounted to the chassis 102 using the track 102j. These are merely exemplary components and attachments. It is possible to connect other vehicle related components and attachments that may be suitable for use with the extruded chassis 102 without any limitations.

Furthermore, as seen in FIG. 2, each of the T-slot profiles 102e-102 includes a void opening 102p. These void openings 102p provide torsional stiffness to the extruded chassis structure 102. Additionally, the void opening 102p facilitates a safe passage for cables and brake lines of the electric mobile platform vehicle 100 and also provides torsional stiffness to the tracks 102i, and 102j of the T-slot profiles 102e-102h.

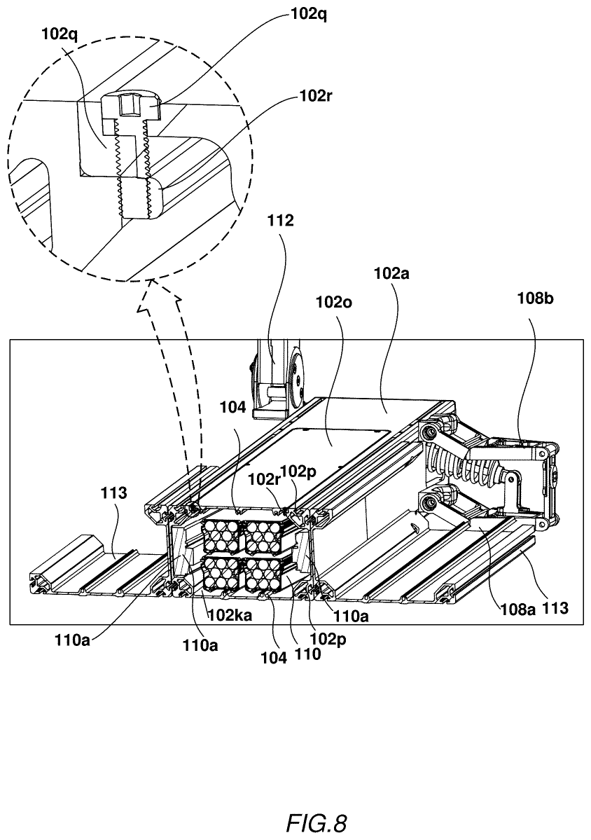

Additionally, as can be best seen in FIG. 2 and FIG. 8, two of the four T-slot profiles 102e-102h, each connecting the top elongated wall 102a to the side walls 102c, 102d includes a lip 102r. The lip 102r extends from the T-slot profiles 102e and 102f. The two lips 102r act as a support for mounting the battery cover 102o thereon. A gasket 102s is placed on the lip 102r and one or more fasteners 102q are used to removably couple the cover 102o over the lip 102r.

Referring again to FIG. 2 in conjunction with 1, the extruded chassis structure 102 further includes at least one reinforcing member 104 configured underside either the top elongated wall 102a or configured underside the bottom elongated wall 102b or configured on both walls 102a, 102b to reinforce the walls 102a, 102b enhancing their rigidity and make them more rigid. The at least one reinforcing member 104 are threaded inside for connecting various fasteners. In a preferred embodiment, the reinforcing member 104 is a C-shaped channel (internally threaded channels) extending along the length of the extruded chassis structure 102 in other words extending along the length of the top and bottom elongated walls 102a, 102b. The reinforcing members 104 are adopted for connecting the front end cap 102l, and the rear end cap 102m at the first end 103a and the second end 103b of the extruded chassis structure 102 as seen at least in FIGS. 3-4. The front end cap 102l, and the rear end cap 102m are connected at the first end 103a and the second end 103b of the extruded chassis structure 102 using one or more attachment provisions 102n located on the front and rear end walls 102l, 102m. In an example, the attachment provisions 102n are provided in the form of slots. One or more fasteners 102q are inserted through these attachment provisions 102n on the front and rear end caps 102l, 102m to connect them to the reinforcing members 104 configured underside the top elongated wall 102a and the bottom elongated wall 102b. The attachment provisions 102n in the form of sots preferably located on the front and rear end caps 102l, 102m may be used for connecting one or more attachments utilizing one or more suitable fasteners 102q. The attachments may include but are not limited to a front bumper mounted on the front end caps 102l, one or more containers for carrying different loads (not seen), a micro car body for urban commuting (not seen), a stretcher for emergency evacuation (not seen), a snowplow for snow removal (not seen), a lawn mower for agricultural use (not seen), one or more seats 112, one or more footsteps 113, one or more racks, one or more additional extruded chassis structures to increase the width of the extruded chassis structure 102 and so on.\

The attachment provisions 102n, and the tracks 102i, and 102j of the T slot profiles 102e-102h help in easily converting an electric platform vehicle 100 to one or more types of utility vehicles.

Additionally, the provided reinforcing members 104 on the extruded chassis structure 102 are also used for mounting one or more frame extenders (not seen), mounting the suspension systems 109 for the electric platform vehicle 100, for supporting one or more battery modules 110 configured within the enclosure 102ka of the extruded chassis structure 102 (FIG. 8). The reinforcing members 104 may act as impact and scratch guard for the bottom elongated wall 102. The reinforcing members 104 also act as mud and water channels to rain them out of the chassis 102.

According to an embodiment, the first opening (102e), and/or the second opening (102f) facilitates changing the wheelbase length of the extruded chassis structure (102) by moving the corresponding pair of control arms (105a, 105b) or (106a, 106b) or (107a, 107b) or (108a, 108b) along the at least one track (102i) of the T-slot profiles (102e-102h).

Now referring to FIGS. 11-14, the proposed extruded chassis structure 102 provides wheelbase length adjustment for vehicle 100. The first opening 102e and/or the second opening 102f facilitates changing the wheelbase length of the extruded chassis structure 102 by moving the corresponding pair of control arms (105a, 105b) or (106a, 106b) or (107a, 107b) or (108a, 108b) along the track 102i of the T-slot profiles 102e-102h. In an example embodiment, the wheelbase adjustment is carried out by moving the pair of control arms (107a, 107b) and (108a, 108b) along the track 102i of the T slot profiles 102e-102h. The user needs to unbolt the respective control arms (107a, 107b) configured on side wall 102c and control arms (108a, 108b) configured on side wall 102d and then slide the rail nut 102q within the tracks 102i for selective location and then retighten the bolt 102q to the rail nut 102q to fix the new position for the rear control arms (107a, 107b) and (108a, 108b). FIG. 11 specifically shows the wheelbase becoming shorter. The rear pair of control arms connecting rear wheels 107, 108 to the chassis 102 is moved to the left (indicated by a small arrow) to make the wheelbase shorter for the extruded chassis 102. If need be, the user can follow the same process and shift the pair of control arms (107a, 107b) and (108a, 108b) to the right again as seen in FIG. 12 for maximum wheelbase length.

The proposed extruded chassis structure 102 and associated components may be made using various suitable materials in different dimensions as required.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

What is claimed is:

1. An extruded chassis structure (102) for an electric platform vehicle (100), comprising:
a top elongated wall (102a) arranged in a spaced-apart relationship with a bottom elongated wall (102b);
a first elongated side wall (102c) arranged in a spaced-apart relationship with a second elongated side wall (102d);
wherein, the top wall (102a), the bottom wall (102b), and the first and second side walls (102c, 102c) are interconnected using at least four T-slot profiles (102e-102h), each located at a corner of the extruded chassis structure (102);
wherein, a first end (103a) and a second end (103b) of the extruded chassis structure (102) are covered by a front end cap (102l), and a rear end cap (102m) forming an enclosed space (102k) there inside, wherein the front end cap (102l) and the rear end cap (102m) provides torsional stiffness against bending to the extruded chassis structure (102); and
wherein each of the T-slot profiles (102e-102h) comprises at least one track (102i, 102j) to facilitate mounting one or more vehicle-related attachments to the extruded chassis structure (102).

2. The extruded chassis structure (102) of claim 1, wherein the enclosed space (102k) embodies an enclosure (102ka) for housing one or more battery modules (110) there inside.

3. The extruded chassis structure (102) of claim 1, wherein the extruded chassis structure (102) is quadrilateral shaped.

4. The extruded chassis structure (102) of claim 1, wherein the extruded chassis structure (102) is made of a light metal.

5. The extruded chassis structure (102) of claim 1, wherein the one or more vehicle-related chassis components are selected from a group of components consisting of a steering assembly (111), suspension systems (109).

6. The extruded chassis structure (102) of claim 1, wherein each of the first elongated side wall (102c) and the second elongated side wall (102d) comprises a first opening (102e), and a second opening (102f) to facilitate configuration of the suspension systems (109) for the electric mobile platform vehicle (100).

7. The extruded chassis structure (102) of claim 1 further comprising at least one reinforcing member (104) configured underside at least one of: the top elongated wall (102a), and the bottom elongated wall (102b) to reinforce the top elongated wall (102a) and the bottom elongated wall (102b) enhancing their rigidity.

8. The extruded chassis structure (102) of claim 7, wherein the at least one reinforcing member (104) is a C channel extending along the length of the extruded chassis structure (102).

9. The extruded chassis structure (102) of claim 7, wherein the at least one reinforcing member (104) is internally threaded and adapted for connecting the front end cap (102l), and the rear end cap (102m) at the first end (103a) and the second end (103b) of the extruded chassis structure (102).

10. The extruded chassis structure (102) of claim 7, wherein the at least one reinforcing member (104) is configured for at least mounting one or more frame extenders, mounting the suspension systems (109) for the electric mobile platform vehicle (100), supporting one or more battery modules (110) configured within the enclosure (102ka), acting as impact and scratch guard for the bottom elongated wall (102b), acting as mud and water channels.

11. The extruded chassis structure (102) of claim 1, wherein each of the T-slot profiles (102e-102h) comprising a void opening (102p) for at least providing torsional stiffness to the extruded chassis structure (102), a safe passage for cables and brake lines of the electric mobile platform vehicle (100), torsional stiffness to the at least one track (102i, 102j) of the T-slot profiles (102e-102h).

12. The extruded chassis structure (102) of claim 1, wherein the front end cap (102l), and the rear end cap (102m) comprises one or more attachment provisions (102n) to mount the front end cap (102l), and the rear end cap (102m) at the first end (103a) and the second end (103b) of the extruded chassis structure (102) by connecting the front end cap (102l), and the rear end cap (102m) using one or more fasteners (102q) that engages the at least one threaded reinforcing member (104).

13. The extruded chassis structure (102) of claim 12, wherein the one or more attachment provisions (102n) are slots.

14. The extruded chassis structure (102) of claim 12, wherein the one or more attachment provisions (102n) are used for connecting one or more attachments utilizing the one or more fasteners (102q), thereby not requiring any welding.

15. The extruded chassis structure (102) of claim 14, wherein the one or more attachments comprises at least a front bumper, a rear bumper, one or more fenders for front and rear, a container for carrying loads, a snowplows for snow removal, a micro car body for urban commuting, a stretcher for emergency evacuation, a lawn mower for agricultural, one or more seats (112), one or more footsteps (113), one or more racks, one or more additional extruded chassis structures to increase the width of the extruded chassis structure (102).

16. The extruded chassis structure (102) of claim 1, wherein four wheels (105-108) of the electric platform vehicle (100) are connected to the extruded chassis structure (102) on the side walls (102c, 102d) utilizing respective pair of control arms (105a, 105b) or (106a, 106b) or (107a, 107b) or (108a, 108b) which are connected to the at least one track (102i) of the T-slot profiles (102e-102h) in proximity to the first and second openings (102e, 102f).

17. The extruded chassis structure (102) of claim 1, wherein the at least one track (102l, 102j) comprises three longitudinal solid-walled sides (114a-114c), and a longitudinal slot (114d) for passage of a fastener for connecting the one or more vehicle-related attachments to the extruded chassis structure (102).

18. The extruded chassis structure (102) of claim 1, wherein the top elongated wall (102a) comprises a cover (102o) configured to allow accessibility to the one or more battery modules (110) housed within the enclosure (102ka) formed within the enclosed space (102k) of the extruded chassis structure (102).

19. The extruded chassis structure (102) of claim 1, wherein the enclosure (102ka) of the enclosed space (102k) of the extruded chassis structure (102) houses one or more controllers (110a) and other electronics positioned adjacent to the first and second side walls (102c, 102c) of the extruded chassis structure (102) to facilitate effective heat dissipation to the first and second side walls (102c, 102c) of the extruded chassis structure (102).

20. The extruded chassis structure (102) of claim 6, wherein the first opening (102e), and/or the second opening (102f) facilitates changing the wheelbase length of the extruded chassis structure (102) by moving the corresponding pair of control arms (105a, 105b) or (106a, 106b) or (107a, 107b) or (108a, 108b) along the at least one track (102i) of the T-slot profiles (102e-102h).

21. The extruded chassis structure (102) of claim 1, wherein two of the at least four T-slot profiles (102e-102h), each connecting the top elongated wall (102a) to the first and second side walls (102c, 102d) comprises a lip (102r) extending therefrom acting as a support for mounting the cover (102o) thereon.

22. The extruded chassis structure (102) of claim 21 further comprises a gasket (102s) placed on the lip (102r) and the one or more fasteners (102q) to removably couple the cover (102o) over the lip (102r).

23. The extruded chassis structure (102) of claim 2, wherein the enclosure (102ka) is waterproof.

24. The extruded chassis structure (102) of claim 23, wherein the enclosure (102ka) is made waterproof by a front separator (102k), and a rear separator (102kc) that seals the enclosure (102ka) from the front end and rear end, the bottom elongated wall (102b) that seals the enclosure (102ka) from the bottom, and a cover (102o) configured to allow accessibility to the one or more battery modules (110) housed within the enclosure (102ka).
